(19) United States
(12) Patent Application Publication
(10) Pub. No.: US 2013/0310201 A1
(43) Pub. Date: Nov. 21, 2013

(54) Apparatus and Method for Simulating a Golf Game Using a Driving Range and a Putting Green

(71) Applicants: Paul Stanley, Virginia Beach, VA (US); Dennis W. Lemley, Virginia Beach, VA (US)

(72) Inventors: Paul Stanley, Virginia Beach, VA (US); Dennis W. Lemley, Virginia Beach, VA (US)

(21) Appl. No.: 13/473,117

(22) Filed: May 16, 2012

(51) Int. Cl. A63B 69/36; G06F 19/00; G09B 29/00

(52) U.S. Cl. 473/409; 283/34; 700/92

(57) ABSTRACT

An apparatus and method using the apparatus to simulate a golf game using a driving range and a putting green. A course card having a pictorial schematic representation of a hole of a golf course is used to plan and record strokes made at the driving range. The golfer estimates the distance and direction from the marked position on the course card to the cup, chooses a club, and then drives a ball in a desired direction and with a selected force towards the green and cup. Each stroke taken by the golfer is recorded on the course card and marks the landing location of the ball from the stroke on the course card. This process continues until the golfer deems that his/her ball would be on the green of the hole being simulated. The hole may then be putted at a putting green.

### FIELD OF THE INVENTION

The invention pertains to the simulated play of a game of golf and, more particularly, to a game of golf played using a driving range or similar facility and a putting green.

### BACKGROUND OF THE INVENTION

The game of golf is well known and widely played. In the game, a golf ball is driven with a club, typically off a tee, towards a hole or cup located a distance away from the tee along a fairway. Typically, more than one hit or stroke of the ball is required to cause the ball to enter the cup. A so-called hole-in-one occurs when the ball is driven into the cup by the first stroke off the tee. Holes-in-one are rare.

After the first stroke off the tee, the ball hopefully lands somewhere on the fairway between the tee and the cup. If the ball is less than optimally hit off the tee, it may land in a area to either side of the fairway called the rough, or possibly in a sand trap (sometimes called a bunker), or in a water hazard. A particularly poorly driven ball may land outside the rough in an area colloquially referred to as a “duffer area”.

The golfer must then play his or her ball from the rough, bunker, or, if possible, from the water hazard. Rules exist for substituting a ball that cannot be retrieved from a water hazard. There is a stroke penalty imposed for an unrecoverable ball, the penalty being added to the golfer's score for the hole.

Once the ball is hit onto the green surrounding the cup, the ball is putted into the cup. The total number of strokes required to move the ball from the tee to the cup is the players score for the hole, a low score being preferable.

Golf courses generally have either nine or eighteen consecutive holes, typically played in order. Actual play on such golf courses is generally expensive, the better known or regarded the course, the higher the admission (i.e., greens fees) and the more difficult it is to obtain a tee off time. In addition to the expenses involved, playing nine or eighteen holes of an actual golf course involves a large amount of walking that may be problematic for some players.

It would, therefore, be desirable to provide a way for golfers to practice there golf game without payment of greens fees and without the extensive walking required on an actual golf course and the expenditure of time required.

### DISCUSSION OF THE RELATED ART

Golf practice devices and games are known in the prior art. For example, U.S. Pat. No. 1,851,423 for GOLF GAME issued Mar. 29, 1932 to Oscar L. Ely teaches a rectangular field having a length approximately equal to the distance from a tee to a cup on a conventional golf course. Arranged along one end of the field are several elevated driving stands from which the entire playing field is visible. Arranged at various distance from the driving stands are a series of holes or cups, each having a suitable green surrounding the cup. In a preferred embodiment, holes located nearer the driving stands are disposed adjacent opposite sides of the field, while those holes further from the driving stands are disposed more inwardly from the sides of the field. The furthest hole in the embodiment chosen for of disclosure is located approximately 210 yards from the driving stands and is disposed approximately midway along the minor axis of the field. Consequently, ELY provides holes located within short, medium, and long driving distances from the driving stands. In some embodiments, no holes or cups are actually present but the spot on the green merely marked by a flag.

U.S. Pat. No. 2,248,053 for GOLF PRACTICE DEVICE issued Jul. 8, 1941 to Lovette M. Bales discloses an arrangement of fairways, roughs, playing tees, targets, and light sources whereby a professional or instructor may observe, criticize and instruct a player under conditions simulating actual course conditions and situations without the loss of time and extensive areas incidental to the use of an actual golf course. The lighting arrangement hereinabove referred to is designed to produce progressively increasing illumination over the playing field with increasing distance from the tee stands, whereby the visibility of the ball is maintained substantially constant throughout the length of the playing field.

U.S. Pat. No. 4,192,510 for APPARATUS FOR SIMULATING A GAME OF GOLF, issued Mar. 11, 1980 to Franklin C. Miller utilizes a conventional golf practice driving range with added greens with flags for approach shots, the conventional practice putting greens and a computer with a viewing screen. The computer is programmable, as by cassette tape, to show in sequence layout and data on each of eighteen holes of a selected classical golf course. The actual drives and approach shots are “played” on the practice driving range and are added to the computer information on the screen to show ball placement on the screened course. A golfer can play realistically on any of the great courses of the world and measure his game against the par for those courses by the process, completing putting out for final score on adjacent practice greens.

U.S. Pat. No. 4,572,512 for GOLF COURSE issued Feb. 25, 1986 to Harold G. Tegart teaches a compact golf course that employs a number of tee positions facing a series of targets at ranges up to 300 yards with distance indicators whereby a player at one the tees can drive tee and fairway shots recording precisely the distance attained for each shot. Chipping greens are provided for the putting phase of the golf game. The golfer moves in sequence from the tee and fairway target range to the chipping range and putting greens. Score cards are provided and layouts of famous courses appear on charts located at each tee position to allow the player to play in sequence the holes of the selected famous courses.

None of the patents, taken singly, or in any combination are seen to teach or suggest the novel apparatus and method of simulating a golf game using a driving range and a putting green of the present invention.

### SUMMARY OF THE INVENTION

In accordance with the present invention there is provided an apparatus and a method of using the apparatus to conduct a simulated golf game using a driving range or similar facility in conjunction with a putting green. A course card showing a pictorial schematic representation of a single hole of a real or imaginary golf course is provided.

The simulated golf game is played by first examining the hole information from the course card (i.e. distances, overall layout of the hole, location of the fairway vs. the rough, trees, sand traps, water hazards, etc.).

The first golfer chooses a club and drives a ball from a tee of the driving range in a manner consistent with a stroke that might be made on the actual hole being simulated. Using range markers on the driving range, the golfer then estimates the length and direction of the drive and marks his/her approximate location on the simulated fairway on the course card. If the ball lies in the rough, a bunker, or water hazard, the course card is marked accordingly. The process for dealing with a ball in a duffer zone is discussed hereinbelow.

The golfer then estimates the distance and direction from the marked position on the course card to the cup, chooses a club, and then drives a second ball from the ground, a mat, turf, etc. (i.e., from anywhere except a tee) in the desired direction and with a selected force towards the green and cup. Driving from a surface other than a tee helps keep the simulation realistic as, on a regular golf course, a golfer's second stroke would not be from a tee but would be from wherever that golfer's ball lies. Each stroke taken by the golfer is recorded on the course card.

The golfer then marks the landing location of the ball from the second stroke on the course card. This process continues until the golfer deems that his/her ball would be on the green of the hole being simulated.

Once the ball is deemed to be on the green and its location has been marked on the course card, the player then typically defers putting and continues to play the remainder of the nine or eighteen holes.

Once all nine or eighteen holes are complete, the golfer moves to a putting green, places his/her ball at the spot on the green from the simulation card for the first hole. Using a putter or other suitable club, the golfer completes the hole, recording all putting strokes and putt distances on the course card.

The ball is then positioned on the green in accordance with the course card for the next hole and the process is repeated until the golfer has putted all the played holes.

If any shot lands in a designated “duffer zone”, the player draws a card from a pack of duffer cards and follows the instructions displayed thereupon.

“Duffer” is a slang term for a poor or mediocre golfer. The term is usually not considered derogatory, but certainly can be. If a person states, for example, that “most of the golfers who play this golf course are duffers,” there's generally nothing insulting about that statement. Typically on many public golf courses, the majority of golfers who play are often mediocre to poor players (e.g., golfers with higher handicaps). However, to call a good golfer (i.e., a low-handicap player) a duffer, is considered to be an insult and in that context the term is considered derogatory. The term duffer is somewhat synonymous with “hacker” in that they both apply to weaker players.

The golf simulation of the invention may be played alone or with others, for example as a traditional foursome.

It is, therefore, an object of the invention to provide an apparatus and method for simulating a game of golf using a driving range and a putting green.

It is another object of the invention to provide an apparatus and method for simulating a game of golf using a driving range and a putting green wherein a course card provides a pictorial schematic representation of a hole of a golf course.

It is an additional object of the invention to provide an apparatus and method for simulating a game of golf using a driving range and a putting green wherein a course card depicts a representation of either a real hole of an actual golf course or an imaginary, constructed hole.

It is a further object of the invention to provide an apparatus and method for simulating a game of golf using a driving range and a putting green wherein a course card contains indicia identifying the hole, a distance, and a par value.

It is a still further object of the invention to provide an apparatus and method for simulating a game of golf using a driving range and a putting green wherein a scoring chart is provided for recording strokes taken when playing each hole.

It is yet another object of the invention to provide an apparatus and method for simulating a game of golf using a driving range and a putting green wherein a pack of duffer cards is used to control play when a ball lands in an identified duffer zone.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a course card of a typical golf hole in accordance with the invention;

FIG. 2 is a simplified top plan view of a golf driving range;

FIGS. 3a-3c are copies of the course card of FIG. 1 showing progressive play of the hole being simulated.

### DETAILED DESCRIPTION OF THE PREFERRED EMBODIMENT

The present invention provides apparatus and method for simulating a golf game using a practice range or the like in cooperation with a putting green.

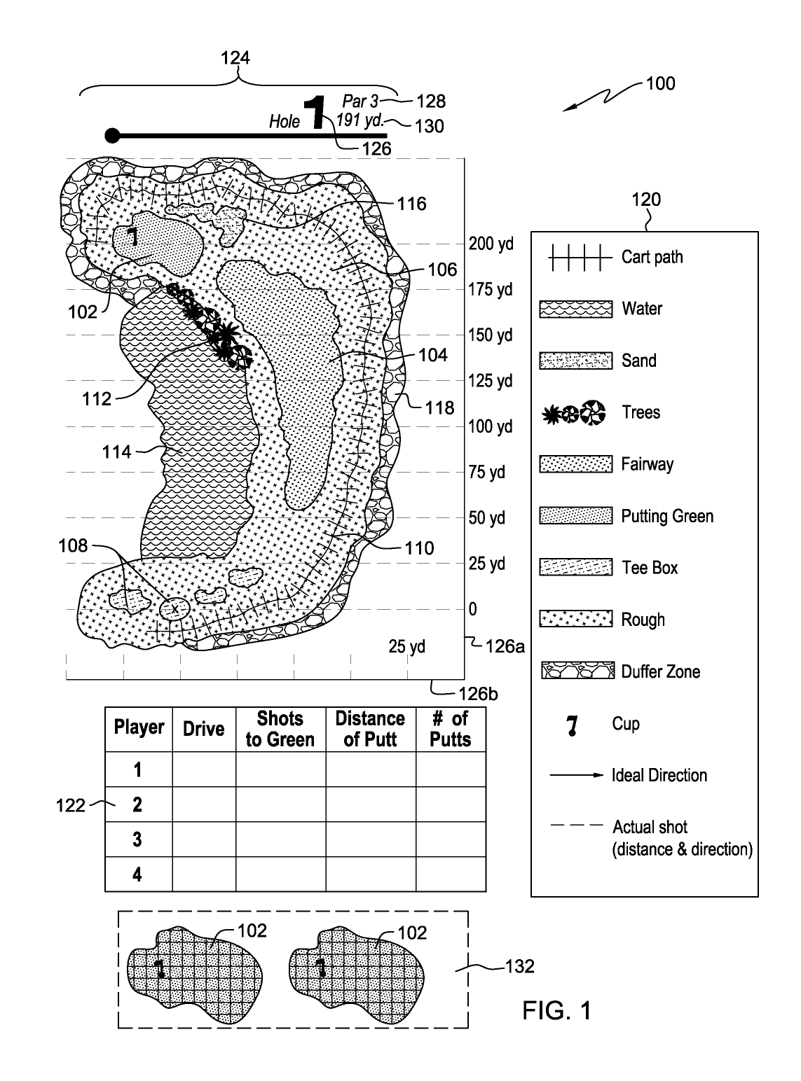

Referring first to FIG. 1, there is shown a course card in accordance with the invention, schematically illustrating a golf hole, generally at reference number 100.

Course card 100 illustrates a golf hole that might be found on an actual golf course, not shown. Course card 100 could illustrate an actual hole from an actual golf course or, alternately, course card 100 may illustrate a contrived golf hole.

Various features of an actual golf hole, not shown, are illustrated on course card 100. For example, tee areas or so-called “tee boxes” 108, fairways 104, rough areas 106, sand hazards or traps 116, water hazards 114, trees and similar obstructions 112, duffer zones 118, cart paths 100, and greens 102 are all shown.

A legend box 120 is provided to help a user of course card 110 interpret the schematic representation of a golf hole.

A scoring box 122 is also provided enabling up to a standard foursome to score their play in accordance with the method of the invention.

Indicia area 124 near the top of course card 100 displays information typically including a hole number 126, a par for the hole 128, and the distance from the tee to the cup 130. It will be recognized that other information may be included in or near indicia area 124 and the invention is not considered limited to the information (i.e., hole number 126, par value 128 and hole distance) chosen for purposes of disclosure. Rather, the invention is intended to include any and all graphic or textual information.

Distance scales 126a, 126b show the yardage from the tee to a particular point along fairway and the width of the hole, respectively.

Green 104 is reproduced multiple times in greens region 132.

In typical uses, either nine or eighteen unique course cards 100 are provided for use in simulating either nine or eighteen holes of play, respectively as would typically be played on an actual golf course.

Course cards 100 have a surface, not specifically identified, adapted for recording marks representing successive locations of a ball on the fairway 104, in the rough 106, in a duffer zone 118, in a sand trap 116, in a water hazard 114, or on the green 102. In addition, other indications may be made on the surface of course card 100 as is described in detail hereinbelow.

Course cards 100 form the basis for the simulation of a game of golf at a driving range or similar facility, neither shown. The method of playing a simulated game of golf in accordance with the method of the invention is now described.

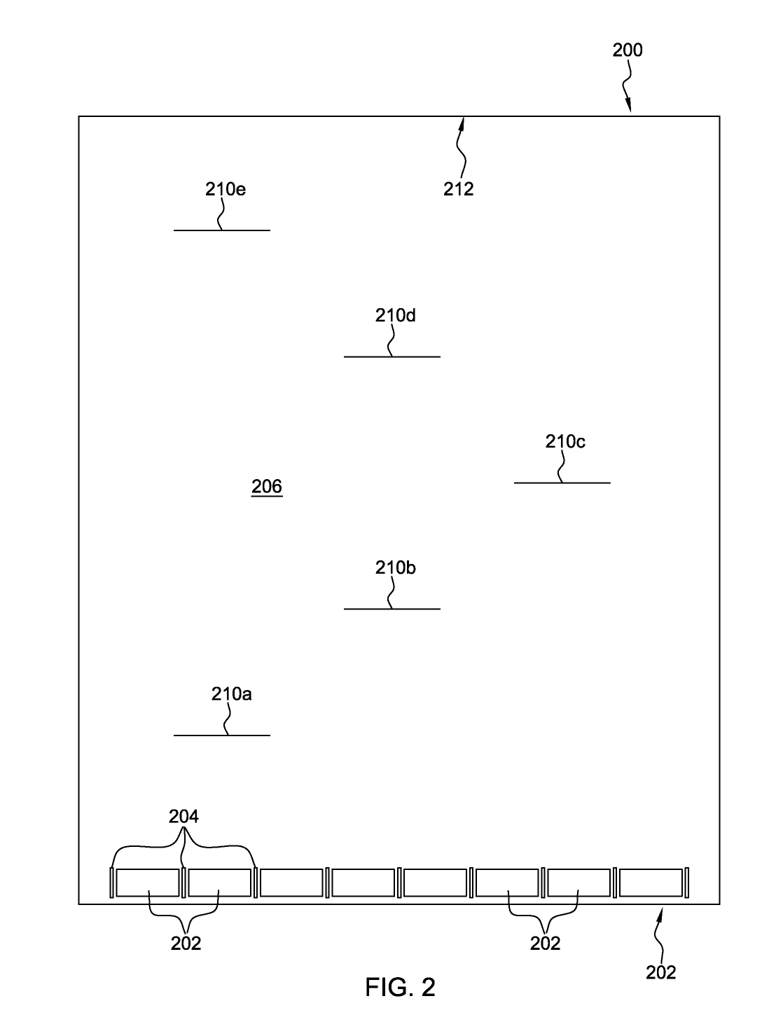

Referring now also to FIG. 2, there is shown a top plan schematic view of a typical driving range, generally at reference number 200. Driving range 200 provides an ideal environment for practicing the method of the invention. Driving range 200 forms no part of the present invention and other suitable facilities, not shown, may readily be substituted therefor.

Driving range consists of a relatively large, generally flat grassy field 206, typically having a length of approximately 400 yards. A width is generally determined by the number of hitting bays 204 that are installed.

A series of hitting bays 202 are disposed adjacent one another along a proximal end 208 of field 206. Each hitting bay has an approximately a 4 foot by 5 foot mat or grassy tee area disposed on the ground therein. If only a few hitting bays 202 are present, they may be arranged in a straight line. If many hitting bays 202 exist, they are generally arranged along an arc so that the distance from each hitting bay 202 to distance markers (i.e., yardage signs) (210a . . . 210e) is substantially the same.

Typically, a barrier 204 is installed between adjacent bays 202. Barriers 202 typically are approximately five feet long and approximately two and a half feet high.

A series of distance markers 210a . . . 210e as disposed on field 206 at predetermined distances (e.g., 50 yards, 100 yards, etc) from hitting bays 202.

Finally, a ball-stopping screen may be deployed at a distal end 212 of field 206. Ball-stopping screens, not shown, may be deployed along the edges, not specifically identified, of field 206 if required.

A driving range 200 or the like is where the method of the present invention may be practiced.

The method of the invention allows a game of golf, normally played on a regulation golf course, to be played.

As used herein, the terms he, him, himself are intended to be gender neutral and, for convenience are used to refer to either men or women playing the simulated golf game.

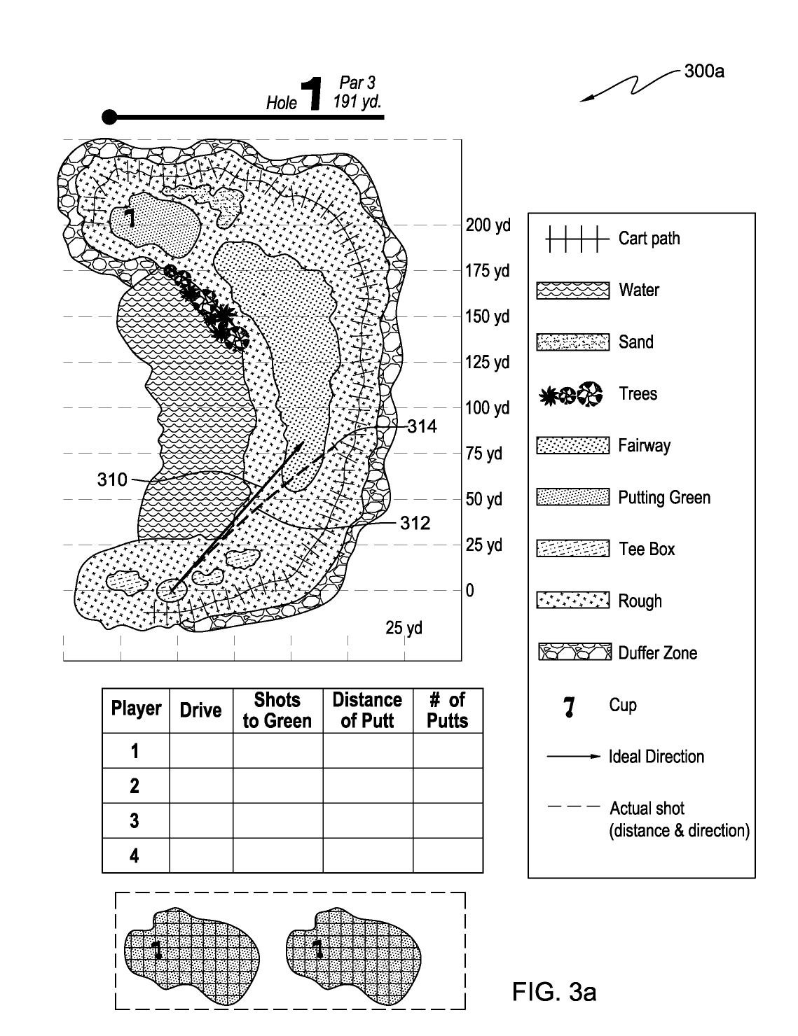

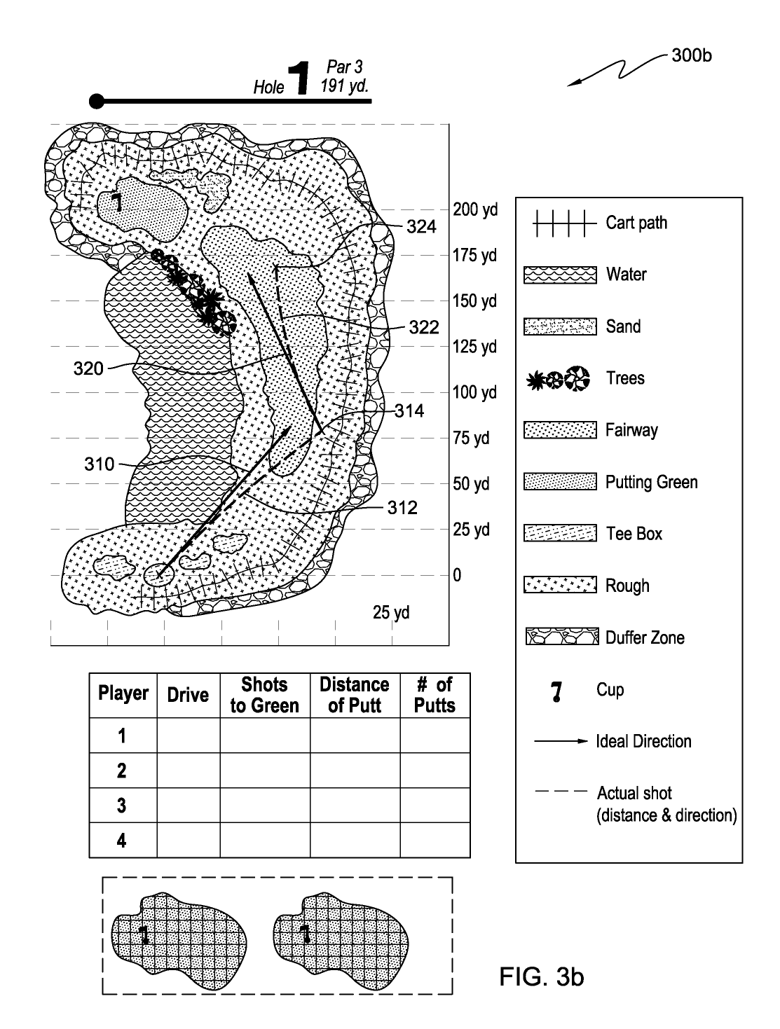

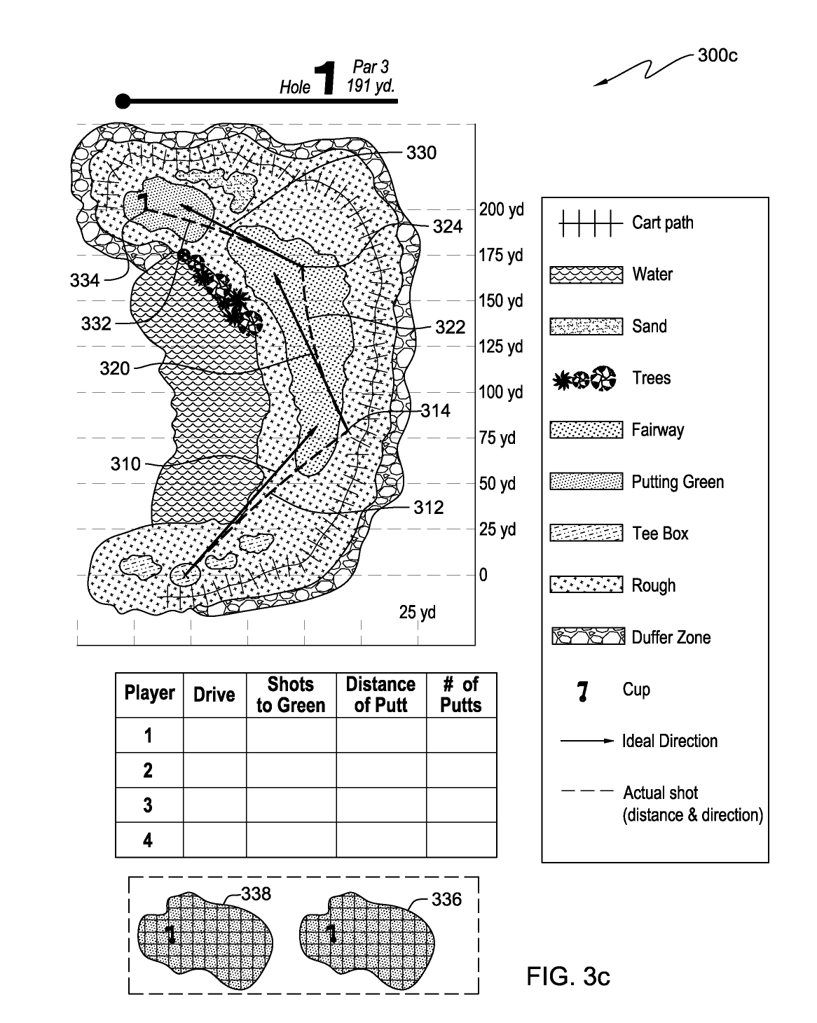

A player equipped with a course card 100 is disposed in a hitting bay 202 of a driving range 200. The player studies course card 100 and imagines himself in the tee box 108 of the hole represented by course card 100, hereinafter the hole. The player then calculates the direction and length of a first drive off the tee if he were playing the hole. He then marks the intended direction and length of the shot on course card 300a (FIG. 3a)

Referring now also to FIG. 3a, there is shown a course card 300a identical to course card 100 of FIG. 1 with the exception that it additionally shows two lines 310 312. Line 310 is the intended direction and length of the shot marked by the player.

The player then actually hits the ball in the intended direction and with a force calculated to land the ball at the intended distance from the tee. With even the best professional golfers, a shot may not land where intended. The player now estimates from the distance markers 210a . . . 210e where his ball actually lies 314 and marks the actual direction and distance 312 on course card 300.

The game continues as the player imagines himself on the actual golf course at point 314 where his ball actually lies. Again, the player estimates in what direction to what distance an ideal shot would be assuming the player were on an actual golf course. Referring now also to FIG. 3b, there is shown a course card 300b, similar to course card 300a of FIG. 3a but with two more lines associated with the second shot toward the hole. Once the player has determined the direction and distance of the second, line 320 on course card 300b. Again, the player strikes the ball in the intended direction and with an intended force. Typically while the first shot may have been from a tee, not shown, the second shot typically is made from grass to better simulate actual play on a golf course.

Play continues in a similar manner. Referring now also to FIG. 3c, there is shown a course card 300c showing the results of the player's first two shots. The player again estimates the direction and distance of a third shot and marks the intended path and distance of course card 300c as line 330. Again, the player strikes the ball in the intended direction and with a force calculated to move the ball to the desired position. The actual direction and distance is marked on course card 300c as line 332 and the ball's actual resting place at reference number 334.

In this example of simulated play chosen or purposes of disclosure, the strokes are illustrated and the ball positioned after the three strokes is on the green 102.

Typically, the player selects a course card 100 associated with the next hole and starts the process again. Typically, after the completion of either eight or sixteen holes, the player moves to a putting green and then putts the entire eight or sixteen holes in succession. It will be recognized that, if desired, each hole may be putted after the play in which the ball is landed on the green 102.

To putt the hole, the player proceeds to a practice putting green, not shown, usually associated with a driving range and places his ball at a position on the green representative (i.e., primarily a distance away from the pin) of position 334 (FIG. 3c) where the ball landed on the green as described hereinabove.

Putting proceeds in accordance with normal putting procedures well know to those of skill in the art. Consequently, putting is not further described or discussed herein. The replica greens 336, 338 near the bottom of course card 300c may be used in a manner similar to the replica of the hole that forms the crux of the novel course card 100. In other words, the putt may be planned and marked on one of the greens 336, 338. After the putting stroke is taken, the ball's actual course may also be recorded. Putting strokes are taken until the putt is “made” and the ball is in the cup.

It will be recognized that course cards 100 may be represented as electronic images and presented to one or more electronic devices having a display, for example a computer, a tablet computer, a PDA, a “smart” phone, an e-reader, or other portable electronic device. An electronic device equipped with a touch screen, for example, a tablet computer, may be used to record the planned and actual paths of a ball directly on the screen. A so-called “app” may be provided to manage the presentation of course card images, record the stroke information for one or more players, and record hole scores directly. Images gathered may be stored and downloaded for future review. For example, a player may wish to play the simulated hole multiple times and compare his results from these multiple attempts. Such comparison may be helpful in isolating flaws in a swing or other problems.

Such electronic images may be stored internally in the electronic device or may be received from an external source via a communications interface. Such devices are typically equipped with electronic communications interfaces using the cellular telephone network via a so-called 3G or 4G data network. Alternately, such devices may utilize a wireless data network (e.g., “wi fi”) to receive such electronic images.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1) A course card for use in simulating play of a golf hole, comprising:
a) a thin, flat course card bearing indicia on at least a first major surface thereof, said indicia graphically and schematically representing at least one feature of a hole of a golf course, said at least one features comprising a tee-off area, a green and at least one other feature chosen from the group: a fairway, a rough, a sand trap or bunker, a water hazard, a tree, a cup, a cart path, and a duffer region;
b) indicia disposed on said first major surface including at least one chosen from the group: a hole number associated with said hole, a par value for said hole, and a distance from a tee disposed in said tee-off area to a point on said green; and
c) a scoring table on said first major surface and adapted for recordation of at least one of the group: a drive, a number of strokes from said tee to said green, a distance of a putt, and a number of putts.

2) The course card for use in simulating play of a golf hole as recited in claim 1, further comprising a yardage scale disposed adjacent said indicia graphically and schematically representing at least one features of a hole of a golf course.

3) The course card for use in simulating play of a golf hole as recited in claim 1, wherein said first major surface is adapted to receive marks thereupon.

4) The course card for use in simulating play of a golf hole as recited in claim 3, wherein said marks received upon said first major surface comprises at least one selected from the group: a line indicating an intended direction for a drive, a line indicating an intended distance for a drive, a line indicating an actual direction resulting from a drive, a distance resulting from of an actual drive, and a point where a ball is located.

5) The course card for use in simulating play of a golf hole as recited in claim 1, wherein said first major surface further comprises indicia comprising advertising.

6) The course card for use in simulating play of a golf hole as recited in claim 1, wherein said course card is presented as an electronic image on an electronic device selected from the group comprising: a computer, a tablet computer, a PDA, a “smart” phone, and other portable electronic devices.

7) The course card for use in simulating play of a golf hole as recited in claim 6, wherein an electronic image is stored internally within said electronic device.

8) The course card for use in simulating play of a golf hole as recited in claim 6, wherein an electronic image is received from an external source via a wireless communications interface.

9) A method of simulating a game of golf using a driving range, the steps comprising:
a) providing a thin, flat course card bearing indicia on at least a first major surface thereof, said indicia graphically and schematically representing at least one feature of a hole of a golf course, said at least one feature comprising a tee-off area, a green and at least one other feature chosen from the group: a fairway, a rough, a sand trap or bunker, a water hazard, a tree, a cup, a cart path, and a duffer region, and indicia disposed on said upper surface including at least one chosen from the group: a hole number associated with said hole, a par value for said hole, and a distance from a tee disposed in said tee-off area to a point on said green, and a scoring table adapted for recordation of at least one of the group: a number of strokes from said tee to said green, a distance of a putt, and a number of putts;
b) using said course card to determine a direction and desired distance of a first drive as if playing said hole defined on said course card;
c) marking said determined direction and desired determined distance on said first major surface of said course card;
d) at a driving range, driving a ball in accordance with said determined direction and desired distance; and
e) recording an actual direction, actual distance, and point where the ball currently lies on said first major surface of said course card.

10) The method of simulating a game of golf using a driving range as recited in claim 9, the steps further comprising:
f) repeating said marking step (c), said driving step (d), and said recording step (e) until said point where said ball currently lies is on said green.

11) The method of simulating a game of golf using a driving range as recited in claim 10, the steps further comprising:
g) recording at least one piece of information associated with said driving step (d) in said scoring table.

12) The method of simulating a game of golf using a driving range as recited in claim 10, the steps further comprising:
g) after said point where said ball currently lies is on said green, placing a ball on a putting green at a point approximately the distance to the cup determined from said course card;
h) putting said ball placed on the green toward the cup.

13) The method of simulating a game of golf using a driving range as recited in claim 12, the steps further comprising:
i) repeating said putting step (h) until said ball placed on said green is in said cup.

14) The method of simulating a game of golf using a driving range as recited in claim 12, the steps further comprising:
j) recording at least one of the values selected from the group: a total number of putts taken, and the distance of at least one of said putts taken on said course card.
